(19) United States
(12) Patent Application Publication
(10) Pub. No.: US 2025/0089788 A1
(43) Pub. Date: Mar. 20, 2025

(54) AEROSOL GENERATING DEVICE

(71) Applicant: KT&G CORPORATION, Daejeon (KR)

(72) Inventors: Hwikyeong AN, Seoul (KR); Sangkyu PARK, Seoul (KR); Jaemin LEE, Siheung-si Gyeonggi-do (KR); Jongsub LEE, Sungnam-si Gyeonggi-do (KR); Daenam HAN, Seoul (KR)

(73) Assignee: KT&G CORPORATION, Daejeon (KR)

(21) Appl. No.: 18/730,947

(22) PCT Filed: Jan. 19, 2023
(86) PCT No.: PCT/KR2023/000977

§ 371 Date: Jul. 22, 2024

(30) Foreign Application Priority Data
Jan. 25, 2022 (KR) 10-2022-0010832
Jul. 26, 2022 (KR) 10-2022-0092614

(51) Int. Cl. A24F 40/465; A24F 40/20; A24F 40/57; A24F 40/60; A24F 40/85

(52) U.S. Cl. CPC A24F 40/465; A24F 40/20; A24F 40/57; A24F 40/60; A24F 40/85

(57) ABSTRACT

An aerosol generating device is provided. The aerosol generating device includes: a body defining a first insertion space having an upper opening; a heater holder configured to be coupled to a heater and inserted into the first insertion space and defining a second insertion space having an upper opening; and an extractor configured to be inserted into the second insertion space and defining a third insertion space having an upper opening.

### TECHNICAL FIELD

The present disclosure is related to an aerosol generating device.

### BACKGROUND ART

An aerosol generating device is a device that extracts certain components from a medium or a substance by producing an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol generating devices has been conducted.

### DISCLOSURE OF INVENTION

### Technical Problem

It is an objective of the present disclosure to solve the above and other problems.

It is another objective of the present disclosure to provide an aerosol generating device that can allow a heater to be easily attached/detached or replaced.

It is another objective of the present disclosure to provide an aerosol generating device that is easy to clean and maintain.

It is another objective of the present disclosure to provide an aerosol generating device with an improved or extended heater replacement period.

It is another objective of the present disclosure to reduce factors that change the taste of a stick.

It is another objective of the present disclosure to provide an aerosol generating device that can facilitate removal of a stick.

It is another objective of the present disclosure to reduce overheating of an aerosol generating device.

It is another objective of the present disclosure to prevent rotation of a heater in a circumferential direction.

It is another objective of the present disclosure to prevent a heater from being separated from an aerosol generating device upon insertion of a stick.

### Solution to Problem

According to one aspect of the subject matter described in this application, an aerosol generating device includes: a body defining a first insertion space having an upper opening; a heater holder configured to be coupled to a heater and inserted into the first insertion space and defining a second insertion space having an upper opening; and an extractor configured to be inserted into the second insertion space and defining a third insertion space having an upper opening.

### Advantageous Effects of Invention

According to at least one of the embodiments of the present disclosure, an aerosol generating device that allows a heater to be easily attached/detached or replaced may be provided.

According to at least one of the embodiments of the present disclosure, an aerosol generating device that is easy to clean and manage may be provided.

According to at least one of the embodiments of the present disclosure, an aerosol generating device with an improved or extended heater replacement period may be provided.

According to at least one of the embodiments of the present disclosure, factors that change the taste of a stick may be reduced.

According to at least one of the embodiments of the present disclosure, an aerosol generating device that facilitates removal of a stick may be provided.

According to at least one of the embodiments of the present disclosure, overheating of an aerosol generating device may be reduced.

According to at least one of the embodiments of the present disclosure, rotation of a heater in a circumferential direction may be prevented.

According to at least one of the embodiments of the present disclosure, separation of a heater from an aerosol generating device may be prevented upon insertion of a stick.

The additional scope of applicability of the present disclosure will be apparent from the following detailed description. However, those skilled in the art will appreciate that various modifications and alterations are possible, without departing from the idea and scope of the present disclosure, and therefore it should be understood that the detailed description and specific embodiments, such as the preferred embodiments of the present disclosure, are provided only for illustration.

### BRIEF DESCRIPTION OF DRAWINGS

FIGS. 1 to 23 illustrate examples of an aerosol generating device according to embodiments of the present disclosure.

### BEST MODE FOR CARRYING OUT THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

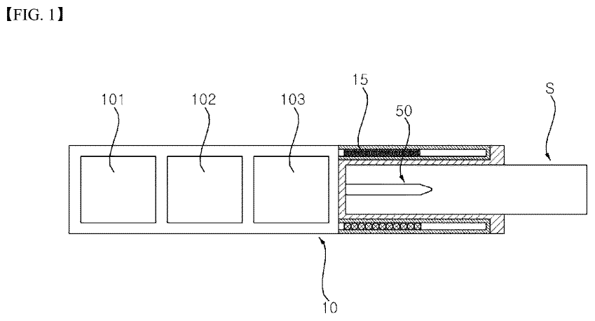

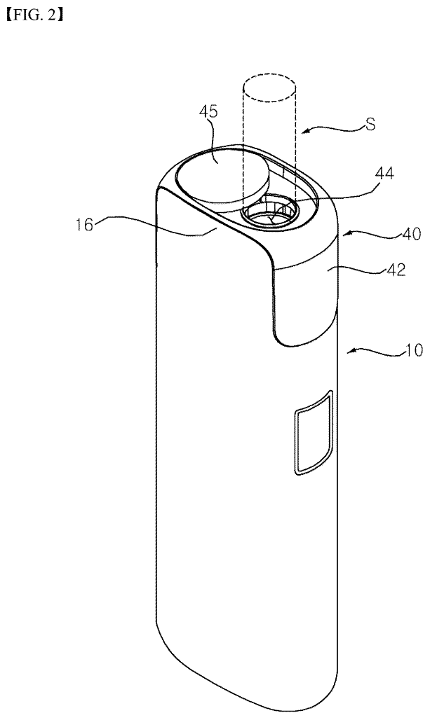

Referring to FIGS. 1 and 2, an aerosol generating device may include at least one of a battery 101, a controller 102, and a sensor 103. At least one of the battery 101, the controller 102, and the sensor 103 may be disposed in a body 10 of the aerosol generating device. The body 10 may provide a space open at the top so as to allow a stick S to be inserted therein. A lower end of the stick S may be inserted into the body 10, and an upper end of the stick S may protrude to an outside of the body 10. A user may inhale air while holding the upper end of the stick 200 exposed to the outside in his or her mouth.

A heater 50 may heat the stick S. The heater 50 may extend upward in an elongated manner in a space where the stick S is inserted. The heater 50 may be inserted into a lower portion of the stick S. The heater 50 may be a resistive heater.

The battery 101 may supply power to operate components of the aerosol generating device. The battery 101 may supply power to at least one of the controller 102, the sensor 103, an induction coil 15, and the heater 50. The battery 101 may supply power required to operate a display, a motor, and the like, installed at the aerosol generating device.

The controller 102 may control the overall operation of the aerosol generating device. The controller 102 may control the operation of at least one of the battery 101, the induction coil 15, and the sensor 103. The controller 102 may control the operation of the display, the motor, and the like, installed at the aerosol generating device. The controller 102 may check the state of each of the components of the aerosol generating device to determine whether the aerosol generating device is in an operable state.

The sensor 103 may sense a temperature of the heater 50. The controller 102 may control the temperature of the heater 50 based on the temperature of the heater 50 sensed by the sensor 103. The controller 102 may transmit information regarding the temperature of the heater 50, sensed by the sensor 103, to the user through a user interface.

The aerosol generating device may include the induction coil 15 surrounding the heater 50. The induction coil 15 may cause the heater 50 to generate heat. The heater 50, which serves as a susceptor, may generate heat by a magnetic field produced by an AC current flowing through the induction coil 15. The magnetic field may pass through the heater 50 and generate an eddy current in the heater 50. The current may cause heat to be generated in the heater 50. Unlike shown in FIG. 1, the heater 50 may be electrically connected to the battery 101. Without the need for the induction coil 15, the heater 50 may generate heat directly by using a current supplied from the battery 101.

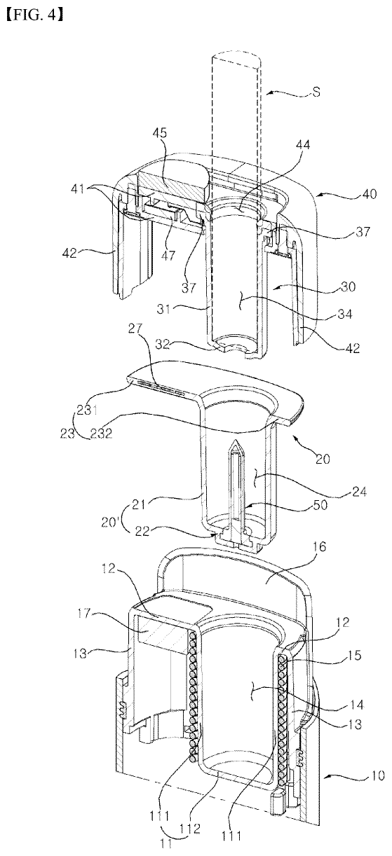

Referring to FIGS. 2 to 4, the body 10 may have a shape elongated vertically. The body 10 may provide a first insertion space 14 therein. The first insertion space 14 may be open at the top. The first insertion space 14 may have a cylindrical shape elongated vertically. The first insertion space 14 may be defined by a body pipe 11 provided in the body 10. The body pipe 11 may include a lateral wall 111 surrounding a circumference of the first insertion space 14 and a lower wall 112 covering a bottom of the first insertion space 14. The lower wall 112 may be formed at a bottom of the body pipe 11. The lateral wall 111 of the body pipe 11 may be referred to as an inner lateral wall 111 of the body 10.

A heater holder 20 may be detachably inserted into the first insertion space 14. The heater holder 20 may provide a second insertion space 24 therein. The second insertion space 24 may be open at the top. The second insertion space 24 may have a cylindrical shape. The second insertion space 24 may be defined by a pipe 20′ of the heater holder 20. The pipe 20′ may include a lateral wall 21 surrounding a circumference of the second insertion space 24 and a lower wall 22 covering a bottom of the second insertion space 24. The lower wall 22 of the pipe 20′ may be referred to as a bottom 22 or a mount 22. The lower wall 22 of the pipe 20′ may define a bottom 22 of the heater holder 20. The heater 50 may be coupled or fixed to the heater holder 20. The pipe 20′ may be referred to as a heater holder pipe 20′.

An extractor 30 may be detachably inserted into the second insertion space 24. The extractor 30 may provide a third insertion space 34 therein. The third insertion space 34 may be open at one side. The third insertion space 34 may have a cylindrical shape. The third insertion space 34 may be defined by a lateral wall 31 and a lower wall 32 of the extractor 30. An outer circumferential surface of the extractor 30 may have a cylindrical shape.

The lower end of the stick S may be inserted into the third insertion space 34, and the upper end of the stick S may protrude to an outside of the aerosol generating device. The heater 50 may heat the first insertion space 14, the second insertion space 24, and the third insertion space 34. The heater 50 may heat the stick S inserted into the third insertion space 34.

Accordingly, the heater 50 may be easily replaced. The replacement of the insertion space 14, 24, 34, and the heater 50 disposed in the insertion space 14, 24, 34 may be difficult due to their small sizes. However, the user may easily replace the heater 50 by removing the heater holder 20 from the aerosol generating device and placing a new heater holder 20 into the aerosol generating device.

In addition, a foreign material (or impurity) generated from the stick S may be extracted through the extractor 30, so that no foreign material remains in the vicinity of the heater 50 and on the heater holder 20. Accordingly, cleaning of the aerosol generating device, namely, near the heater 50 may be easier, and the convenience of management may be improved. Also, a replacement period of the heater 50 may be extended by reducing factors that decrease the performance of the heater 50 and by improving durability of the heater 50. Further, factors that change the taste of the stick S may be reduced.

A lower end of the heater 50 may be fixed to the mount 22. The heater 50 may be elongated toward the opening of the second insertion space 24. The heater 50 may be formed in a cylindrical shape and have a pointed upper end that narrows toward the top. As another example, the heater 50 may have a shape extending in a circumferential direction, and may be coupled to the lateral wall 21 of the heater holder 20. However, this is just an example. The shape of the heater 50 is not limited to those described above or shown in the drawings, and any other shape may be used, so long as the heater 50 can be coupled to the heater holder 20 and heat the stick S inserted into the third insertion space 34.

The heater holder 20 may be insert-injected to the heater 50. The heater holder 20 may have high heat resistance and excellent rigidity. For example, the heater holder 20 may be made of polyetheretherketone (PEEK). However, the material of the heater holder 20 is not limited thereto.

The lower wall 32 of the extractor 30 may be open to define a through-hole 35. The through-hole 35 may be open at the top and the bottom. When the extractor 30 is inserted into the second insertion space 24, the heater 50 may protrude to the third insertion space 34 by passing through the through-hole 35. When the stick S is inserted into the third insertion space 34, the heater 50 may be inserted into the lower portion of the stick S.

The induction coil 15 may surround the first insertion space 14. The induction coil 15 may be wound around the lateral wall 111 of the body pipe 11. The induction coil 15 may surround the heater 50. The induction coil 15 may allow the heater 50 to generate heat. As another example, the heater 50 may generate heat by using power supplied from a power supply source in direct electrical connection therewith through a terminal provided at the heater holder 20.

Accordingly, the stick S may be easily removed from the heater 50. The user may easily remove the stick S from the heater 50 by separating the extractor 30 and the heater holder 20 from each other. As the stick S inserted into the extractor 30 is removed from the heater 50, the stick S may be more easily separated from the extractor 30. The stick S may be removed without separating the extractor 30 and the heater holder 20 from each other.

In addition, a foreign material generated from the stick S may be extracted through the extractor 30, so that no foreign material remains in the vicinity of the heater 50 and on the heater holder 20. Accordingly, cleaning of the aerosol generating device, namely, near the heater 50 may be easier, and the convenience of management may be improved. Also, a replacement period of the heater 50 may be extended by reducing factors that decrease the performance of the heater 50 and by improving durability of the heater 50. Further, factors that change the taste of the stick S may be reduced.

The heater holder 20 may be disposed between the body 10 and the extractor 30. The lateral wall 111 of the body pipe 11 may surround the lateral wall 21 of the heater holder 20. The lower wall 112 of the body pipe 11 may face the lower wall 22 of the heater holder 20. The lateral wall 21 of the heater holder 20 may surround the lateral wall 31 of the extractor 30. The lower wall 22 of the heater holder 20 may face the lower wall 32 of the extractor 30.

The lateral wall 31 of the extractor 30 may be spaced inward from the lateral wall 21 of the heater holder 20. The lower wall 32 of the extractor 30 may be spaced upward from the lower wall 22 of the heater holder 20. Air may flow between the extractor 30 and the heater holder 20, pass through the through-hole 35, and then be delivered to the stick S inserted into the third insertion space 34.

An upper wall 12 of the body 10 may extend outward from an upper end of the body pipe 11 along a horizontal direction. The upper wall 12 of the body 10 may cover an upper end of the induction coil 15. An outer lateral wall 13 of the body 10 may extend downward from an outer end of the upper wall 12 of the body 10. The outer lateral wall 13 of the body 10 may face the lateral wall 111 of the body pipe 11. The outer lateral wall 13 of the body 10 may be spaced outward from the body pipe 11. The induction coil 15 may be disposed between the body pipe 11 and the outer lateral wall 13 of the body 10.

An upper case 40 may be detachably coupled to the body 10. The upper case 40 may be coupled to an upper side of the body 10. The upper case 40 may cover the surrounding of the first insertion space 14 and the surrounding of an upper portion of the body 10. The upper case 40 may have an insertion hole 44. The stick S may be inserted into the insertion hole 44. The upper case 40 may include a cap 45 that opens and closes the insertion hole 44. The cap 45 may slide transversely to open and close the insertion hole 44. The heater holder 20 may be disposed between the body 10 and the upper case 40.

The upper case 40 may include an upper case body 41. The upper case body 41 may be open at the top and the bottom to define the insertion hole 44. The insertion hole 44 may be formed at a position eccentric to one side from a center of the upper case body 41. A lower surface of the upper case body 41 may have a shape corresponding to the upper wall 12 of the body 10. The lower surface of the upper case body 41 may extend in the horizontal direction to be parallel with the upper wall 12 of the body 10. The cap 45 may be installed to be slidable on the upper case body 41.

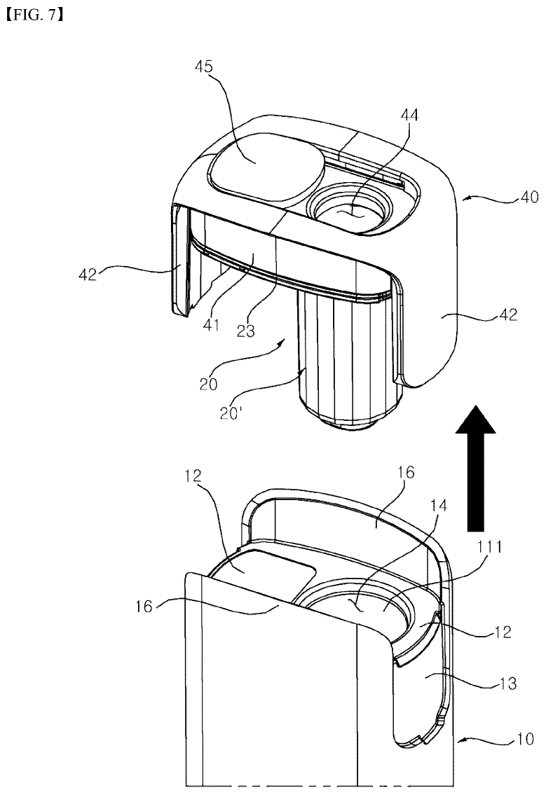

The upper case 40 may include an upper case wing 42. The upper case wing 42 may extend downward from each of both sides of the upper case body 41. A portion of a lateral portion of the upper case body 41 may be exposed between a pair of upper case wings 42 (see FIG. 7). The upper case wing 42 may be referred to as an upper case grip 42.

The extractor 30 may be coupled to the upper case 40. An upper end of the extractor 30 may be coupled to the upper case 40, and a lower end of the extractor 30 may protrude downward of the upper case 40. The extractor 30 may be coupled to a position corresponding to the insertion hole 44. The insertion hole 44 may be located over the third insertion space 34. The insertion hole 44 may allow the third insertion space 34 and the outside of the aerosol generating device to communicate with each other.

The upper end of the extractor 30 may be coupled to the upper case body 41. The extractor 30 may extend downward from the upper case body 41. The extractor 30 may be disposed between the pair of upper case wings 42.

The body 10 may include a body wing 16. The body wing 16 may extend upward from an edge of the upper wall 12 of the body 10. A pair of body wings 16 may be disposed opposite each other with respect to the upper portion of the body 10 (see FIG. 7). The body wing 16 may be formed at a position non-overlapping with the upper case wing 42.

When the upper case 40 is coupled to the body 10, the upper case 40 may define an exterior (or outer appearance) of an upper portion of the aerosol generating device. When the upper case 40 is coupled to the body 10, the body wing 16 may cover the lateral portion of the upper case body 41 exposed between the pair of upper case wings 42. When the upper case 40 is coupled to the body 10, the upper case wing 42 may cover the outer lateral wall 13 of the body 10.

Accordingly, the user may more easily remove the extractor 30 from the body 10. Without the inconvenience of gripping the extractor 30 inserted into the second insertion space 24, the user may remove the extractor 30 by separating the upper case 40 from the body 10 while holding the exterior of the upper case 40. For example, the user may easily remove the upper case 40 and the extractor 30 from the body 10 by holding and pulling the pair of upper case wings 42 from the body 10.

The extractor 30 may include an engaging protrusion 37. The engaging protrusion 37 may protrude outward from an upper outer circumferential surface of the extractor 30 along the horizontal direction. A plurality of engaging protrusions 37 may be provided. The plurality of engaging protrusions 26 may be spaced apart from each other in the circumferential direction. The engaging protrusion 37 may be inserted into and caught in a recess formed in the upper case body 41 near the insertion hole 44, allowing the extractor 30 to be fixed to the upper case 40. The engaging protrusion 37 may be engaged with the upper case body 41 in the circumferential direction.

Accordingly, the extractor 30 may be prevented from being rotated in the circumferential direction with respect to the upper case 40 during insertion and removal of the stick S.

The heater holder 20 may include an extension portion 23. The extension portion 23 may be formed at an upper end of the heater holder 20. The extension portion 23 may extend outward from an upper end of the pipe 20′ along the horizontal direction. The extension portion 23 may have a plate shape. One side of the extension portion 23 may be longer with respect to the pipe 20′. The extension portion 23 may be referred to as a heater holder extension portion 23.

The extension portion 23 may have a shape corresponding to the upper wall 12 of the body 10. The extension portion 23 may be formed horizontally to the upper wall 12 of the body 10. When the pipe 20′ is inserted into the first insertion space 14, the extension portion 23 may be supported or seated on the upper wall 12 of the body 10. The upper wall 12 of the body 10 may support the extension portion 23, and the extension portion 23 may support the pipe 20′. The pipe 20′ may be spaced upward from the lower wall 112 of the body pipe 11 while hanging on the extension portion 23, thereby forming an air gap. An outer circumferential surface of the pipe 20′ may be spaced inward from the lateral wall 111 of the body pipe 11 to form an air gap.

The extension portion 23 may have a shape corresponding to the lower surface of the upper case body 41. The extension portion 23 may be formed horizontally to the lower surface of the upper case body 41. When the upper case 40 is coupled to the body 10, the extractor 30 may be inserted into the pipe 20′, allowing the extension portion 23 to be in contact with the lower surface of the upper case body 41.

A first coupling member 27 may be fixed to the heater holder 20. For example, the first coupling member 27 may be fixed to the extension portion 23. The first coupling member 27 may be fixed to an inner or outer surface of the extension portion 23. The heater holder 20 may be insert-injected to the first coupling member 27 and the heater 50.

The extension portion 23 may include a first extension portion 231 and a second extension portion 232. The first extension portion 231 may extend from the pipe 20′ to one side, and the second extension portion 232 may extend from the pipe 20′ to another side. The first extension portion 231 may extend longer than the second extension portion 232. A circumference of the first extension portion 231 may be greater than a circumference of the second extension portion 232. The first extension portion 231 may be wider in the horizontal direction than the second extension portion 232. With respect to the pipe 20′ extending downward from the extension portion 23 of the plate shape, one side may be defined as the first extension portion 231 and another side may be defined as the second extension portion 232. The pipe 20′ may extend downward from a portion eccentric to one side from a center of the extension portion 23.

Of the portions of the extension portion 23, the first coupling member 27 may be fixed to the first extension portion 231 extending longer to one side with respect to the pipe 20′. The first coupling member 27 may have a plate shape. The first coupling member 27 may be widely disposed at the first extension portion 23 in the horizontal direction. The position at which the first coupling member 27 is disposed is not limited thereto. For example, the first coupling member 27 may be fixed to the pipe 20′.

The first coupling member 27 may be made of a magnetic material. The first coupling member 27 may be ferromagnetic. For example, the first coupling member 27 may be made of stainless steel. However, the material of the first coupling member 27 is not limited thereto.

A second coupling member 47 may be fixed to the upper case 40. The second coupling member 47 may be fixed inside the upper case body 41. The second coupling member 47 may be adjacent to the lower surface of the upper case body 41. However, the position at which the second coupling member 47 is disposed is not limited thereto. For example, the second coupling member 47 may be fixed to the upper case wing 42. As another example, the second coupling member 47 may be fixed to the extractor 30. The second coupling member 47 may be disposed at a position corresponding to the first coupling member 27.

An attractive force may act between the second coupling member 47 and the first coupling member 27. For example, the first coupling member 27 may be a ferromagnetic material, and the second coupling member 47 may be a magnet. However, the material of the first coupling member 27 and the material of second coupling member 47 are not limited thereto.

A third coupling member 17 may be fixed inside the body 10. The third coupling member 17 may be adjacent to the upper wall 12 of the body 10. The third coupling member 17 may be disposed at a position corresponding to the first coupling member 27. However, the position at which the third coupling member 17 is disposed is not limited thereto. For example, the third coupling member 17 may be adjacent to the lateral wall 111 of the body pipe 11. An attractive force may act between the third coupling member 17 and the first coupling member 27. For example, the first coupling member 27 may be a ferromagnetic material, and the third coupling member 17 may be a magnet. However, the material of the first coupling member 27 and the material of the third coupling member 17 are not limited thereto.

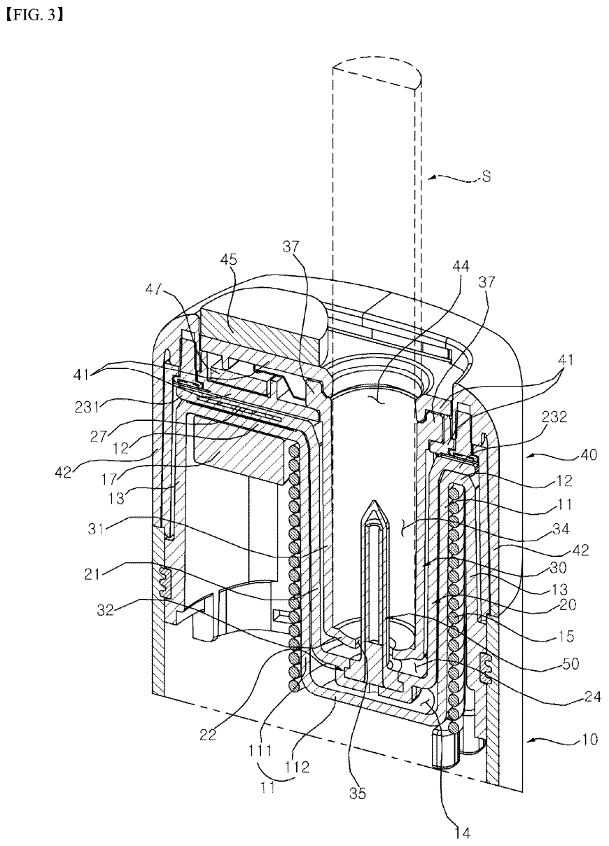

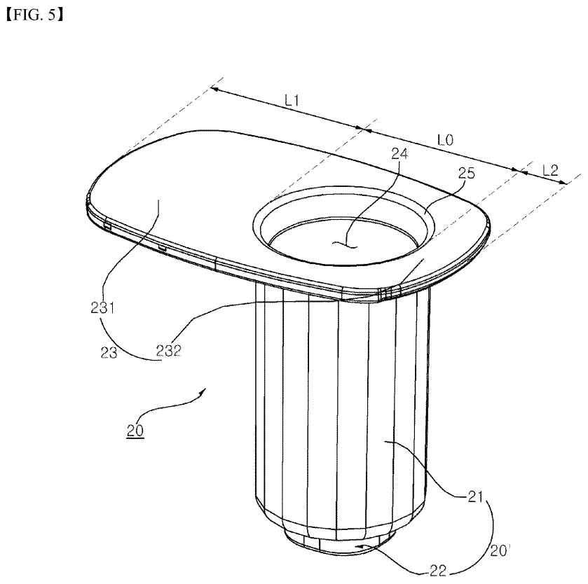

Referring to FIG. 5, an outer circumferential surface of the lateral wall 21 of the pipe 20′ may form a plurality of angles in the circumferential direction. A transverse plane or section of the outer circumferential surface of the lateral wall 21 of the pipe 20′ may have a polygonal shape. The outer circumferential surface of the lateral wall 21 of the pipe 20′ may be elongated vertically, and may include a plurality of surfaces arranged at an angle to each other along the circumferential direction. The outer circumferential surface of the pipe 20′ may be spaced inward from the lateral wall 111 of the body pipe 11 so as to form an air gap (see FIG. 3). The heater 50 may be surrounded by the extractor 30 and the pipe 20′. The extractor 30 and the pipe 20′ may be spaced apart from each other to form an air gap.

Accordingly, the amount of heat, which is generated from the heater 50, transferred to the body pipe 11 (see FIG. 3) through the pipe 20′ may be reduced, thereby reducing overheating of the aerosol generating device.

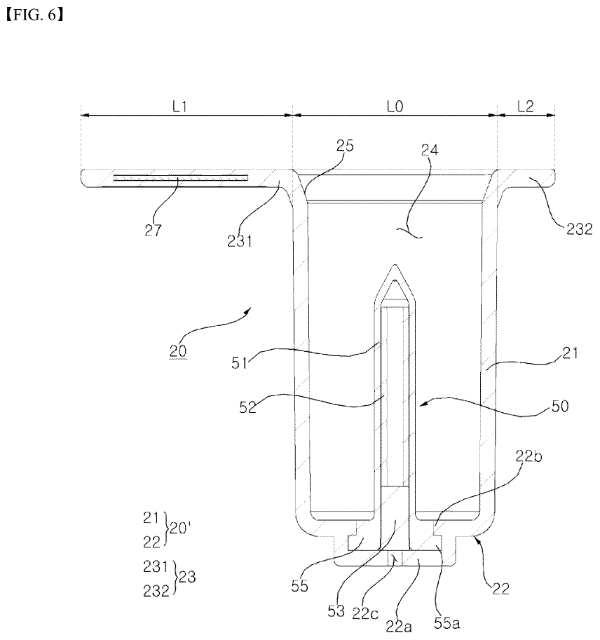

Referring to FIG. 6, a guide portion 25 may be formed on an upper inner circumferential surface of the pipe 20′. The guide portion 25 may be disposed between the pipe 20′ and the extension portion 23. The guide portion 25 may be in contact with the opening of the second insertion space 24. The guide portion 25 may be inclined downward. The guide portion 25 may extend in the circumferential direction to surround the opening of the second insertion space 24.

Accordingly, the guide portion 25 may come in contact with a lower portion of the extractor 30, thereby guiding the extractor 30 to be easily inserted into the second insertion space 24.

The lower end of the heater 50 may be inserted into and fixed to the mount 22. The heater 50 may include a heater rod 51. The heater rod 51 may define an exterior of the heater 50. The heater rod 51 may be elongated vertically. The heater rod 51 may have a cylindrical shape. The heater rod 51 may be provided therein with a hollow open at the bottom. The hollow may be elongated vertically. The hollow of the heater rod 51 may have a cylindrical shape. The heater rod 51 may have a pointed upper end that narrows toward the top. The heater rod 51 may have high thermal expandability, excellent thermal insulation, and low thermal conductivity. The heater rod 51 may have high rigidity. For example, the heater rod 51 may be made of zirconia. However, the material of the heater rod 51 is not limited thereto.

The heater 50 may include a heating portion 52. The heating portion 52 may be inserted into the hollow of the heater rod 51. The heating portion 52 may be elongated vertically. The heating portion 52 may have a cylindrical shape. The heating portion 52 may be made of a resistive metal. Heat generated from the heating portion 52 may be transferred to an outside of the heater 50 through the heater rod 51. The heating portion 52 may be disposed at a height corresponding to the third insertion space 34 (see FIG. 3). A lower end of the heating portion 52 may be adjacent to a lower end of the through-hole 35.

The heater 50 may include a support 53. The support 53 may be inserted into the hollow of the heater rod 51. The support 53 may be disposed under the heating portion 52. The support 53 may be fixed to the heater rod 51 in the hollow. The support 53 may support a lower portion of the heating portion 52. A lower end of the support 53 may be supported by a bottom 22a of the mount 22. A hole 22c that is disposed at a center of the mount 22 may be formed by the process of insert-injecting the heater holder 20. A width of the hole 22c may be less than a width of the support 53 to thereby prevent separation of the support 53. The hole 22c may be excluded. The support 53 may have high heat resistance. The support 53 may not be thermally deformed by heat generated by the heating portion 52. The support 53 may be made of polyamide. However, the material of the support 53 is not limited thereto.

The heater 50 may include a flange 55. The flange 55 may be formed at a lower end of the heater rod 51. The flange 55 may extend outward from an outer circumferential surface of the lower end of the heater rod 51 along the horizontal direction. The flange 55 may extend in a circumferential direction of the heater rod 51. The lower end of the heater rod 51 and the flange 55 may be inserted into the mount 22. As the heater holder 20 is insert-injected to the heater 50, the mount 22 may be integrally coupled to the flange 55.

A transverse section of an outer circumferential surface of the flange 55 may have a non-circular shape. An inner circumferential surface of the mount 22 may have a shape corresponding to the outer circumferential surface of the flange 55. The inner circumferential surface of the mount 22 and the outer circumferential surface of the flange 55 may be engaged with each other in the circumferential direction. Accordingly, the heater 50 may be prevented from being rotated in the circumferential direction with respect to the heater holder 20 when the stick S is inserted into or removed from the heater 50.

The flange 55 may include a first engaging portion 55a. The first engaging portion 55a may protrude outward from a circumference of the flange 55. The first engaging portion 55a may be formed at a lower portion of the flange 55. The first engaging portion 55a may extend along the circumference of the flange 55.

The mount 22 may include a second engaging portion 22b. The second engaging portion 22b may protrude inward toward a recess of the mount 22. The second engaging portion 22b may have a shape corresponding to the first engaging portion 55a. The first engaging portion 55a may be disposed under the second engaging portion 22b. The first engaging portion 55a and the second engaging portion 22b may overlap vertically. The second engaging portion 22b may support the first engaging portion 55a, thereby preventing the flange 55 from being separated upward from the mount 22.

The extension portion 23 may extend longer to one side with respect to the pipe 20′ or the second insertion space 24. With respect to one horizontal direction, a length L1 of the first extension portion 231 may be greater than a length L2 of the second extension portion 232. The length L1 of the first extension portion 231 may be greater than a diameter L0 of the second insertion space 24. Alternatively, the length L1 of the first extension portion 231 may be closer to the diameter L0 of the second insertion space 24 than the length L2 of the second extension portion 232. The first coupling member 27 may have a plate shape. The first coupling member 27 may be horizontally fixed to the first extension portion 231.

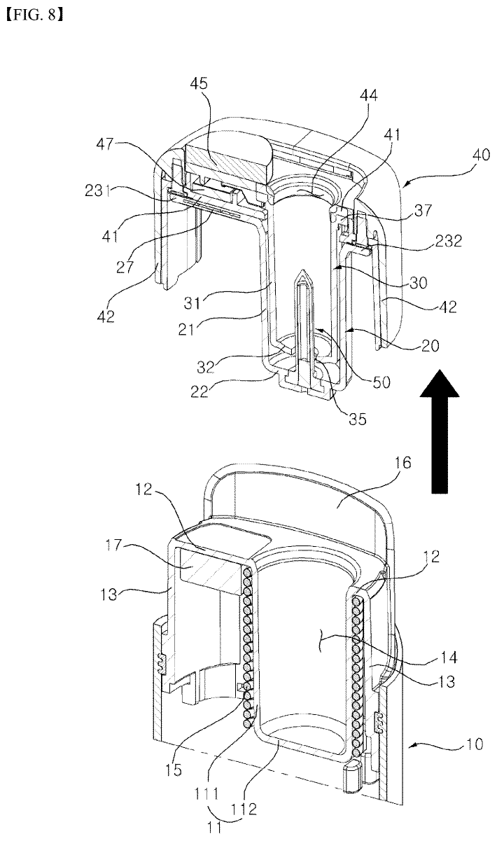

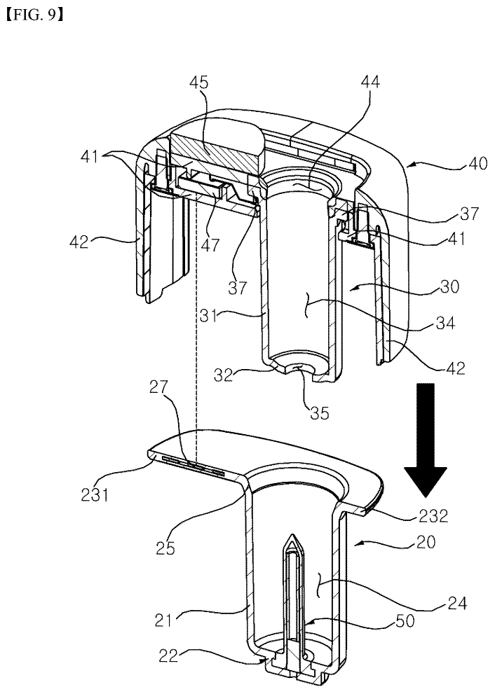

Referring to FIGS. 7 to 9, the upper case 40 may be detached from the body 10. The heater holder 20 may be detachably coupled to the upper case 40. When the upper case 40 is detached from the body 10, the heater holder 20 may be removed together with the upper case 40 from the body 10 while being coupled to the upper case 40. In a state where the upper case 40 to which the heater holder 20 is coupled is separated from the body 10, the heater holder 20 may be detached from the upper case 40.

In another example, the heater holder 20 may be detachably coupled to the extractor 30. When the extractor 30 is detached from the body 10, the heater holder 20 may be removed together with the extractor 30 from the body 10 while being coupled to the extractor 30. In a state where the extractor 30 to which the heater holder 20 is coupled is separated from the body 10, the heater holder 20 may be detached from the extractor 30.

The first coupling member 27 and the second coupling member 47 may exert an attractive force on each other. The first coupling member 27 and the second coupling member 47 may allow the heater holder 20 to be detachably coupled to the upper case 40 and/or the extractor 30. In one example, the first coupling member 27 and the second coupling member 47 may be magnets that attract each other. In another example, one of the first coupling member 27 and the second coupling member 47 may be a ferromagnetic material, and the other may be a magnet. However, without being limited to those described above, any other configuration may be used, so long as the first coupling member 27 and the second coupling member 47 attract each other through an electric force or a magnetic force.

The extension portion 23 may define a horizontal surface corresponding to the lower surface of the upper case body 41. The first extension portion 231 may define a horizontal surface corresponding to the lower surface of the upper case body 41. An upper surface of the extension portion 23 may be horizontally supported by the upper case body 41. An area supported by the upper case body 41 may be greater in the first extension portion 231 than in the second extension portion 232.

The first coupling member 27 may have a plate shape. The first coupling member 27 may be horizontally fixed to the first extension portion 231. The second coupling member 47 may be disposed adjacent to the lower surface of the upper case body 41. The second coupling member 47 may be formed at a position corresponding to the first coupling member 27. Due to the attractive force acting between the first coupling member 27 and the second coupling member 47, the first extension portion 231 may come in contact with the lower surface of the upper case body 41.

In another example, the heater holder 20 may be detachably coupled to the upper case 40 by a screw coupling. In this case, the heater holder 20 may be rotated in the circumferential direction so that the heater holder 20 is removed from or coupled to the upper case 40 by the screw coupling. Alternatively, the heater holder 20 and the upper case 40 may be detachably coupled to each other using a fastening screw. In another example, the heater holder 20 may be detachably coupled to the upper case 40 by a snap-fit coupling. In this case, one of the heater holder 20 and the upper case 40 may have a coupling hook, and the other may have a recess to which the hook is coupled. However, this is just an example, and the method of detachably coupling the heater holder 20 to the upper case 40 is not limited to those described above. The heater holder 20 may be detachably coupled to the upper case 40 in various known methods.

The heater holder 20 that is coupled to the upper case 40 may protrude downward from the upper case 40. The heater holder 20 may be disposed between the pair of upper case wings 42. The pipe 20′ may protrude downward from the upper case body 41 in a manner of protruding downward further than the upper case wing 42. This may make it easier to hold the heater holder 20.

Accordingly, the heater holder 20 may not only be easily detached from the upper case 40 but may also be securely coupled to the upper case 40. In addition, the heater 50 may be conveniently replaced.

Further, the stick S may be easily removed from the heater 50. The user may easily remove the stick S from the heater 50 by separating the extractor 30 and the heater holder 20 from each other. As the stick S inserted into the extractor 30 is separated from the heater 50, the stick S may be more easily removed from the extractor 30.

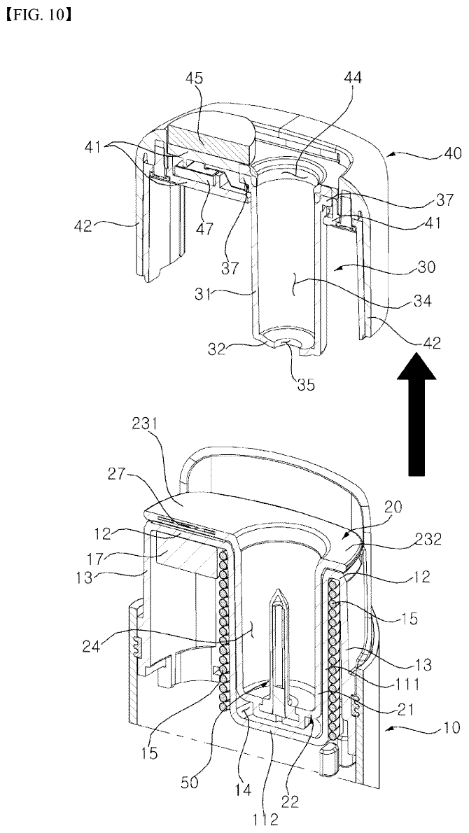

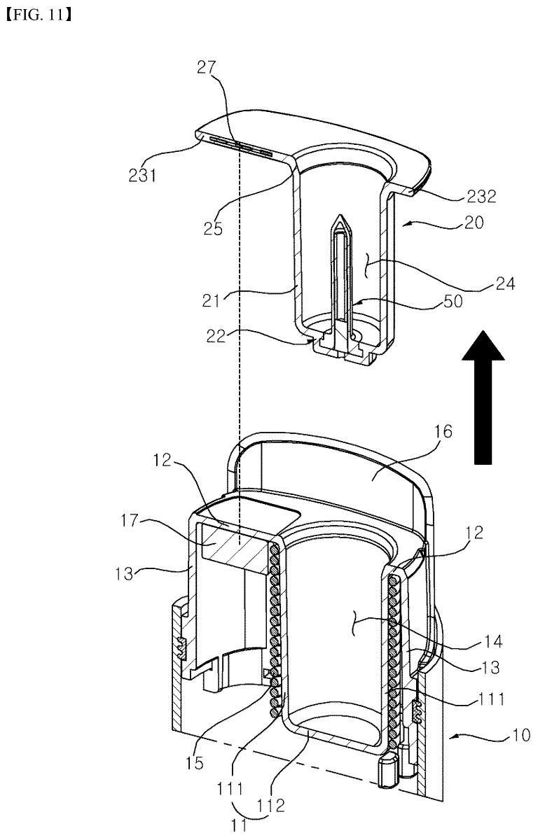

Referring to FIGS. 10 and 11, the heater holder 20 may be detachably coupled to the body 10. In a state where the heater holder 20 is coupled to the body 10, the upper case 40 and/or the extractor 30 may be detached from the body 10 and the heater holder 20. The heater holder 20 may be separated from the body 10 with the upper case 40 and/or the extractor 30 being removed from the body 10 and the heater holder 20.

The first coupling member 27 and the third coupling member 17 may exert an attractive force on each other. The first coupling member 27 and the third coupling member 17 may allow the heater holder 20 to be detachably coupled to the body 10. In one example, the first coupling member 27 and the third coupling member 17 may be magnets that attract each other. In another example, one of the first coupling member 27 and the third coupling member 17 may be a ferromagnetic material, and the other may be a magnet. However, it is not limited to those described above, and any other configuration may be used, so long as the first coupling member 27 and the third coupling member 17 attract each other through an electric force or a magnetic force.

The extension portion 23 may cover the upper wall 12 of the body 10, and the pipe 20′ may be inserted into the first insertion space 14. The extension portion 23 may define a horizontal surface corresponding to the upper wall 12 of the body 10. The first extension portion 231 may correspond to the upper wall 12 of one side of the body 10, and the second extension portion 232 may correspond to the upper wall 12 of another side of the body 10. The lower surface of the extension portion 23 may be horizontally supported by the upper wall 12 of the body 10. An area supported by the body 10 may be greater in the first extension portion 231 than in the second extension portion 232.

The first coupling member 27 may have a plate shape. The first coupling member 27 may be horizontally fixed to the first extension portion 231. The third coupling member 17 may be disposed adjacent to the upper wall 12 of the body 10. The third coupling member 17 may be formed at a position corresponding to the first coupling member 27. The first coupling member 27 may be disposed at the first extension portion 231, and the third coupling member 17 may be disposed adjacent to the upper wall 12 of one side of the body 10 covered by the first extension portion 231. Due to the attractive force acting between the first coupling member 27 and the third coupling member 47, the first extension portion 231 may come in contact with the upper wall 12 of the body 10.

In another example, the heater holder 20 may be detachably coupled to the body 10 by a screw coupling. In this case, the heater holder 20 may be rotated in the circumferential direction so that the heater holder 20 is removed from or coupled to the body 10 by the screw coupling. Alternatively, the heater holder 20 and the body 10 may be detachably coupled to each other using a fastening screw. In another example, the heater holder 20 may be detachably coupled to the body 10 by a snap-fit coupling. In this case, one of the heater holder 20 and the body 10 may have a coupling hook, and the other may have a recess to which the hook is coupled. However, this is just an example, and the method of detachably coupling the heater holder 20 to the body 10 is not limited to those described above. The heater holder 20 may be detachably coupled to the body 10 in various known methods.

The extension portion 23 that is coupled to the body 10 may be exposed upward from the body 10. The extension portion 23 may be disposed between the pair of body wings 16. The extension portion 23 may be disposed adjacent to the outer lateral wall 13 of the body 10 or disposed at a position vertically parallel to the outer lateral wall 13 between the pair of body wings 16. This may make it easier to hold the heater holder 20.

Accordingly, the heater holder 20 may not only be easily detached from the body 10 but may also be securely coupled to the body 10. In addition, the heater 50 may be conveniently replaced.

Further, the stick S may be easily removed from the heater 50. The user may easily remove the stick S from the heater 50 by separating the extractor 30 and the heater holder 20 from each other. As the stick S inserted into the extractor 30 is separated from the heater 50, the stick S may be more easily removed from the extractor 30.

The first coupling member 27 may be disposed between the second coupling member 47 and the third coupling member 17. The first coupling member 27 and the second coupling member 47 may exert an attractive force on each other, and the first coupling member 27 and the third coupling member 17 may exert an attractive force on each other. For example, each of the second coupling member 47 and the third coupling member 17 may be a magnet, and the first coupling member 27 may be a magnet that exerts an attractive force on each of the second coupling member 47 and the third coupling member 17 between the second coupling member 47 and the third coupling member 17. In another example, the first coupling member 27 may be a ferromagnetic material, and each of the second coupling member 47 and the third coupling member 17 may be a magnet. However, without being limited to those described above, any other configuration may be used, so long as the first coupling member 27 and the second coupling member 47 attract each other and the first coupling member 27 and the third coupling member 17 attract each other through an electric force or a magnetic force.

Accordingly, the user may selectively couple the heater holder 20 to any one of the body 10 or the extractor 30 with the upper case 40 and/or the extractor 30 being removed from the body 10. In addition, the upper case 40 and/or the extractor 30 may be more easily and securely coupled to the body 10.

The attractive force between the first coupling member 27 and the second coupling member 47, and the attractive force between the first coupling member 27 and the third coupling member 17 may be different from each other. For example, the attractive force between the first coupling member 27 and the second coupling member 47 may be greater than the attractive force between the first coupling member 27 and the third coupling member 17.

Accordingly, when detaching the upper case 40 and/or the extractor 30 from the body 10, the heater holder 20 may be removed together from the body 10. In addition, when coupling the upper case 40 and/or the extractor 30 to the body 10 while the heater holder 20 is coupled to the upper case 40 and/or the extractor 30, the upper case 40 may be more easily coupled to the body 10 and maintain a more stable coupling state due to the attractive force between the first coupling member 27 and the third coupling member 17.

In another example, the attractive force between the first coupling member 27 and the third coupling member 17 may be greater than the attractive force between the first coupling member 27 and the second coupling member 47. Accordingly, when detaching the upper case 40 and/or the extractor 30 from the body 10, the heater holder 20 may remain coupled to the body 10, and the stick S may be more easily removed from the extractor 30 by being separated from the heater 50.

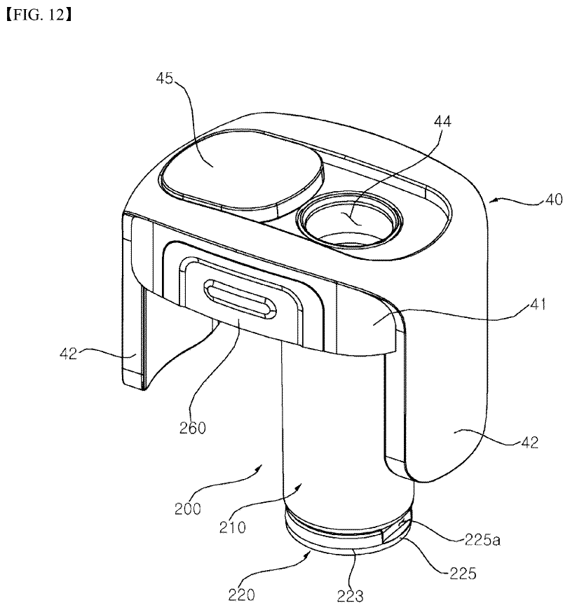

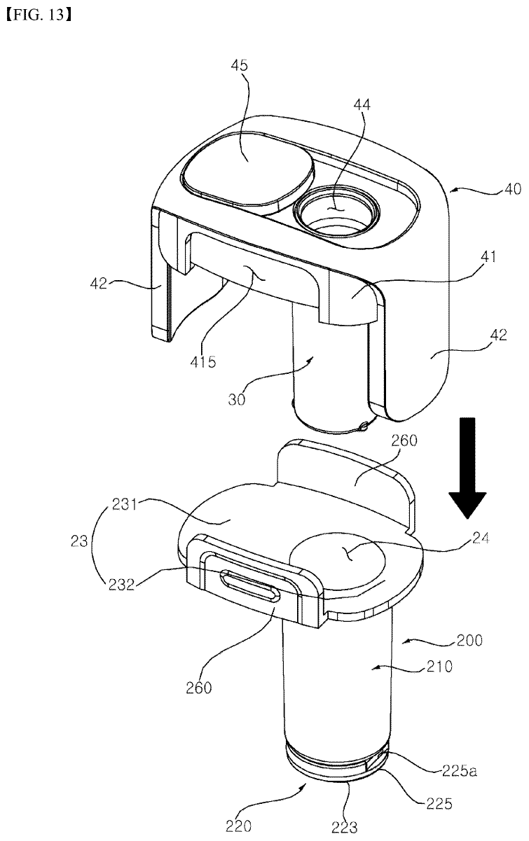

Referring to FIGS. 12 and 13, a heater holder 200 may further include a heater holder wing 260. The heater holder wing 260 may be formed at an upper portion of the heater holder 200. The heater holder wing 260 may extend upward from the extension portion 23. The heater holder wing 260 may be formed on each of both sides of the extension portion 23. A pair of heater holder wings 260 may each be formed at a corresponding position between the pair of upper case wings 42. The first coupling member 27 may be disposed at the extension portion 23 and/or the heater holder wing 260.

A lateral portion of the upper case body 41 may be recessed downward between the pair of upper case wings 42 to define a wing insertion recess 415. A pair of wing insertion recesses 415 may be provided at positions corresponding to the pair of heater holder wings 260, respectively. The wing insertion recess 415 may have a shape corresponding to the heater holder wing 260. The heater holder wing 260 may be referred to as a heater holder grip 260. The wing insertion recess 415 may be referred to as a grip insertion recess 415 or a grip recess 415.

When the heater holder 200 is coupled to the upper case 40, the heater holder wing 260 may cover the lateral portion of the upper case body 41 between the pair of upper case wings 42. The heater holder wing 260 may be inserted into the wing insertion recess 415. The upper case wing 42 may be exposed to an outside of the upper case 40 between the pair of upper case wings 42.

Accordingly, the heater holder 200 may be more easily detached from the upper case 40. The user may easily remove the upper case 40 and the heater holder 200 by holding and pulling the pair of heater holder wings 260 downward from the upper case 40. The heater holder wing 260 may have a portion protruding outward or a concave-convex shape for grip convenience.

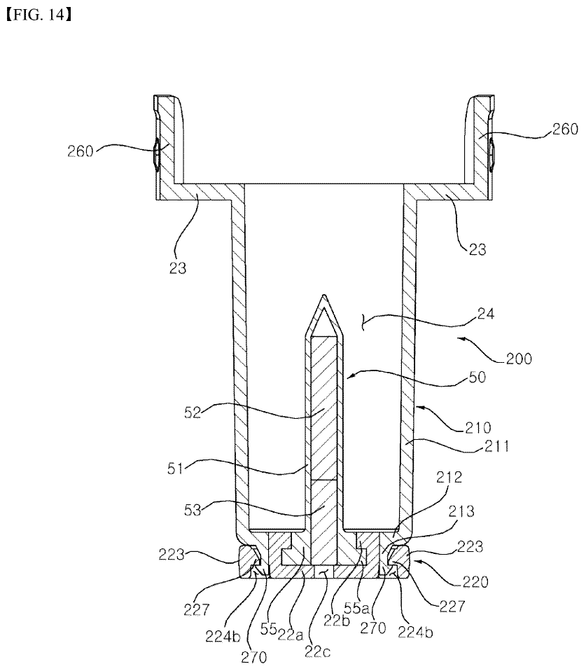

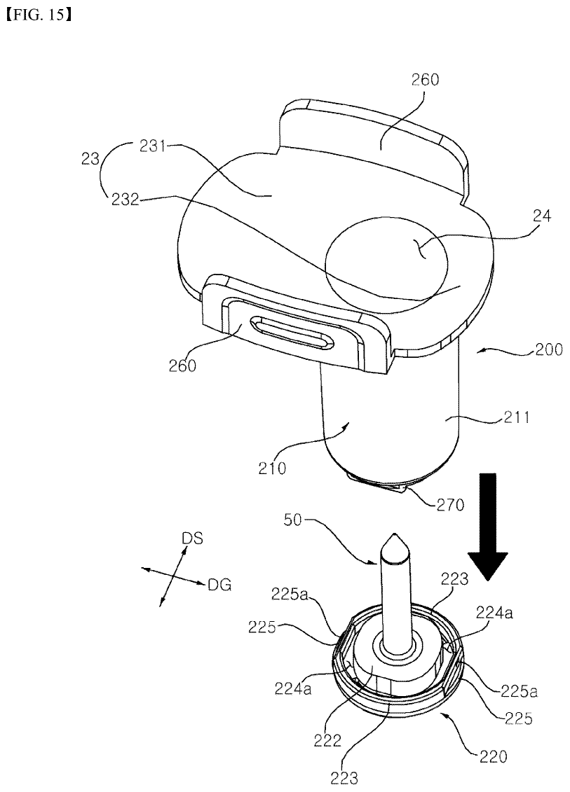

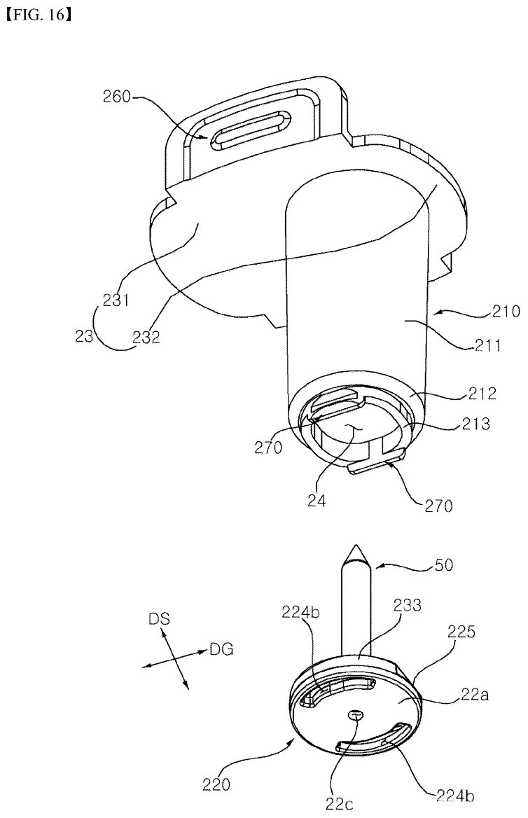

Referring to FIGS. 14 to 16, a pipe 210 may be open at the top and the bottom. A lateral wall 211 of the pipe 210 may surround the second insertion space 24. A bottom 212 of the pipe 210 may protrude radially inward from a lower end of the lateral wall 211 of the pipe 210. The bottom 212 of the pipe 210 may be open.

A mount 220 may be coupled to a lower end of the pipe 210. The mount 220 may cover the opening of the bottom 212 of pipe 210. The flange 55 formed at the lower end of the heater 50 may be fixed to the mount 220. The heater 50 may protrude from the mount 220 to the second insertion space 24.

The mount 220 may be detachably coupled to the lower end of the pipe 210. The pipe 210 may include a hook 270. The hook 270 may protrude downward from the bottom 212 of the pipe 210. A pair of hooks 270 may be disposed opposite each other with respect to the pipe 210. The mount 220 may include an engaging portion 227. A pair of engaging portions 227 may be formed at positions corresponding to the pair of hooks 270, respectively. The engaging portion 227 may be fastened to the hook 270, allowing the mount 220 and the pipe 210 to be detachably coupled to each other. When the mount 220 is coupled to the pipe 210, the hook 270 may be disposed inside the mount 220. For example, the mount 220 may be detachably coupled to the pipe 210 in a snap-fit manner.

The pipe 210 may include a pipe rim 213. The pipe rim 213 may be formed at the lower end of the pipe 210. The pipe rim 213 may protrude downward from the bottom 212 of the pipe 210 that extends inward from the lateral wall 211 of the pipe 210. The pipe rim 213 may be recessed inward from a circumference of the pipe 210. The pipe rim 213 may define a circumference.

The mount 220 may include a rim insertion recess 224a open at the top. The mount 220 may be recessed downward to define the rim insertion recess 224a. The rim insertion recess 224a may define a circumference.

The mount 220 may include a bottom 22a, an inner peripheral wall 222, and an outer peripheral wall 223. The bottom 22a may have a disk shape. The outer peripheral wall 223 may extend upward from an edge of the bottom 22a. The outer peripheral wall 223 may extend along a circumference of the bottom 22a. The inner peripheral wall 222 may extend upward from the bottom 22a. The inner peripheral wall 222 may be spaced inward from the outer peripheral wall 223. The rim insertion recess 224a may be formed between the outer peripheral wall 223 and the inner peripheral wall 222.

The rim insertion recess 224a may have a shape corresponding to the pipe rim 213. The pipe rim 213 may be inserted or press-fitted into the rim insertion recess 224a. The mount 220 may be made of a material having elasticity. For example, the mount 220 may be made of a plastic material. In another example, the mount 220 may be made of a rubber material. However, the material of the mount 220 is not limited thereto.

The engaging portion 227 may protrude inward from the outer peripheral wall 223 along the horizontal direction. The engaging portion 227 may protrude from the outer peripheral wall 223 to the rim insertion recess 224a. The hook 270 may protrude outward from the pipe rim 213 along the horizontal direction. When the pipe rim 213 is inserted into the rim insertion recess 224a, the hook 270 may be fastened to the engaging portion 227. The bottom 22a of the mount 220 may be open at a position corresponding to the engaging portion 227 and the hook 270 to define a hook hole 224b. The hook hole 224b may be located under the rim insertion recess 224a. The hook hole 224b may be in communication with the rim insertion recess 224a. The hook 270 may be inserted into the hook hole 224b to be fastened to the engaging portion 227. When the hook 270 is fastened to the engaging portion 227, the hook hole 224b and the rim insertion recess 224a may be expanded or stretched due to elastic deformation. The hook hole 224b may be referred to as a deformation hole 224b.

The pipe rim 213 and the rim insertion recess 224a may be configured to be engaged with each other in the circumferential direction. A circumference of the pipe rim 213 and a circumference of the rim insertion recess 224a may each have a transverse section with a non-circular shape. For example, the circumference of the pipe rim 213 and the circumference of the rim insertion recess 224a may each include a curved section and a linear section. However, the shape of the pipe rim 213 and the shape of the rim insertion recess 224a are not limited thereto.

An outer circumferential surface of the outer peripheral wall 223 of the mount 220 may be equal or similar to a circumference of an outer circumferential surface of the pipe 210. The outer circumferential surface of the outer peripheral wall 223 of the mount 220 may be less than the circumference of the first insertion space 14.

The mount 220 may be exposed to an outside of the pipe 210. The outer peripheral wall 223 of the mount 220 may surround the lower end of the pipe 210. A mount grip 225 may protrude outward from the outer peripheral wall 223 of the mount 220. The outer peripheral wall 223 of the mount 220 may be recessed to define a mount grip recess 225a. The mount grip 225 may protrude under the mount grip recess 225a in the horizontal direction. The mount grip 225 and the mount grip recess 225a may be formed at a position non-overlapping with the engaging portion 227 and the hook 270. A pair of mount grips 225 may be provided on both sides of the mount 220.

Accordingly, the user may hold and remove the mount 220 from the pipe 210 to clean or replace the heater 50 or the heater holder 200. For example, the user may detach the mount 220 and the pipe 210 from each other by bending the mount 220 while holding the mount grip 225 to release the hook connection.

In addition, the mount 220 may be prevented from being rotated in the circumferential direction with respect to the pipe 210 when inserting or removing the stick S into or from the heater 50.

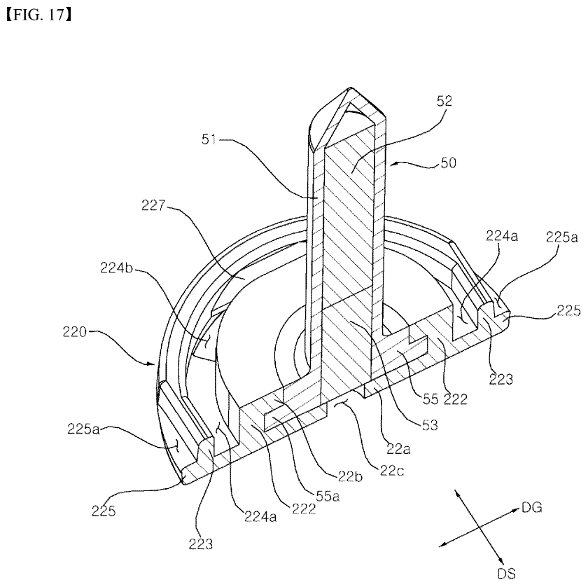

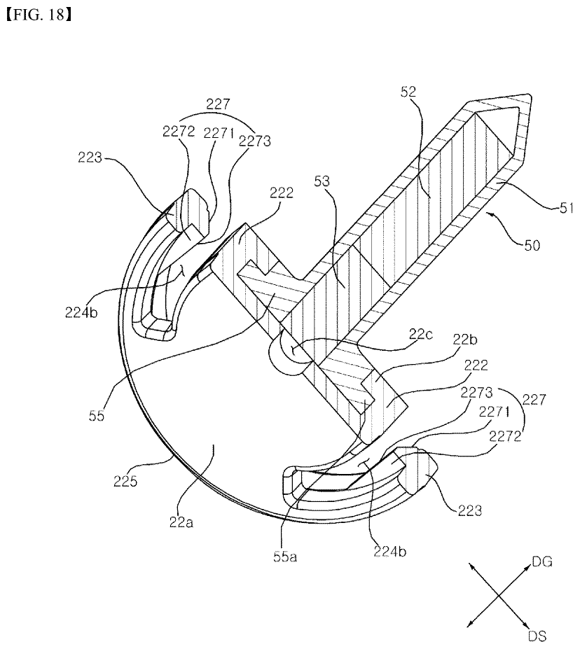

Referring to FIGS. 17 and 18, the pair of mount grips 225 may be provided on both sides of the mount 220 to be disposed opposite each other. The pair of engaging portions 227 may formed on both sides of the mount 220 to be disposed opposite each other.

A direction in which the pair of engaging portions 227 is formed may be referred to as an axial direction DS or a fixed end direction DS. A direction in which the pair of mount grips 225 is formed may be referred to as a grip direction DG. The axial direction DS and the grip direction DG may intersect each other. The axial direction DS and the grip direction DG may be perpendicular to each other.

Referring to FIG. 18, the engaging portion 227 may include a first inclined surface 2271 and a first flat surface 2272. The first inclined surface 2271 may define an upper surface of the engaging portion 227. The first inclined surface 2271 may be inclined inward from an upper end of the engaging portion 227 toward the bottom. The first flat surface 2272 may define a lower surface of the engaging portion 227. The first flat surface 2272 may define a surface in the horizontal direction.

The first flat surface 2272 may protrude inward from an inner circumferential surface of the outer peripheral wall 223 of the mount 220 along the axial direction DS. Unlike shown in FIG. 18, the first flat surface 2272 may protrude inward in a convex manner along the axial direction DS, so as to have a section that gradually narrows in a protruding direction.

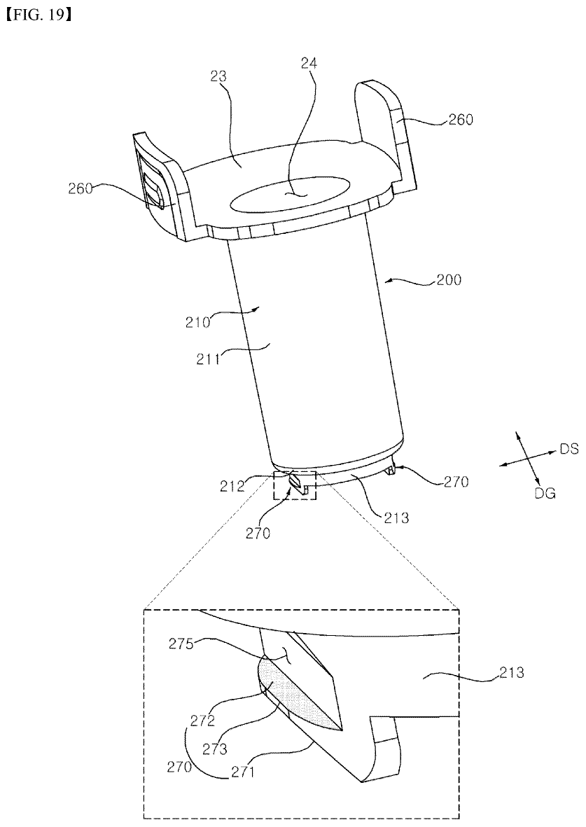

Referring to FIG. 19, the hook 270 may include a second inclined surface 271 and a second flat surface 272. The second inclined surface 271 may define a lower surface of the hook 270. The second inclined surface 271 may be inclined outward from a lower end of the hook 270 toward the top. The second flat surface 272 may define an upper surface of the hook 270. The second flat surface 272 may define a surface in the horizontal direction. The second flat surface 272 may be formed parallel to the first flat surface 2272.

The second flat surface 272 may protrude outward from the pipe rim 213 in a convex manner along the axial direction DS. The second flat surface 272 may include a section that gradually narrows in a protruding direction. The second flat surface 272 may have an edge defining a curved line, and may gradually narrow in the protruding direction. The second flat surface 272 may gradually narrow toward both ends thereof along the grip direction DG.

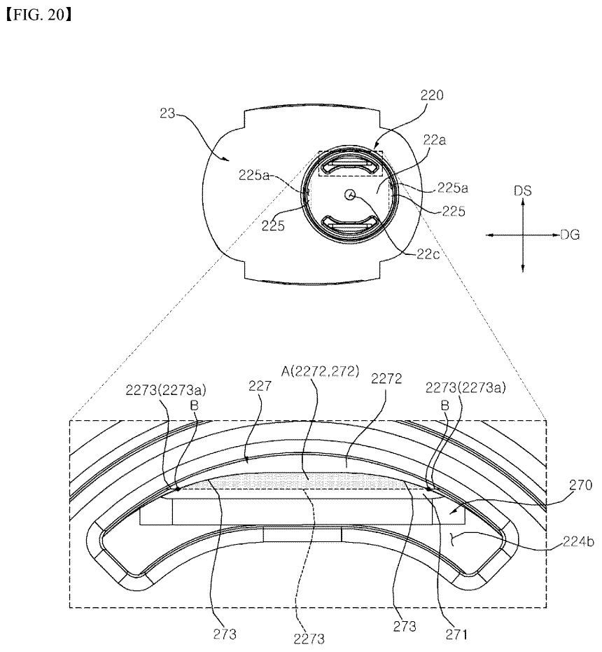

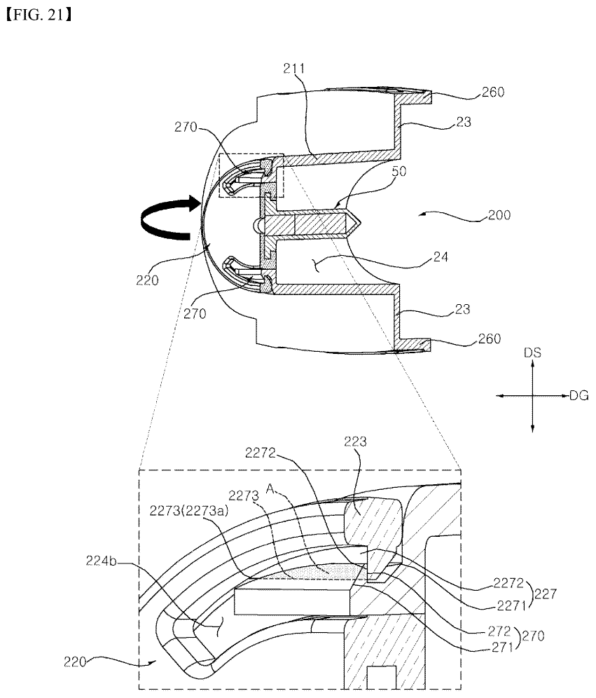

Referring to FIGS. 20 and 21, the hook 270 may be fastened to the engaging portion 227. At least one of the hook 270 and the engaging portion 227 may include an inclined surface that guides the outer peripheral wall 223 to expand or stretch outward when the hook 270 is fastened to the engaging portion 227. When the hook 270 is fastened to the engaging portion 227, the first inclined surface 2271 and the second inclined surface 271 may come in contact with each other, causing the outer peripheral wall 223 of the mount 220 to stretch outward, thereby guiding the hook 270 to be drawn into the hook hole 224b and be fastened to the engaging portion 227. The deformed outer peripheral wall 223 may be restored to its original state.

The hook 270 and the engaging portion 227 may be fastened to each other in a snap-fit manner, which is not pulled apart by a vertical external force. The first flat surface 2272 and the second flat surface 272 may protrude toward each other in the horizontal direction. When the hook 270 is fastened to the engaging portion 227, the first flat surface 2272 and the second flat surface 272 may be in surface contact with each other in the horizontal direction. A surface where the first flat surface 2272 and the second flat surface 272 come in contact with each other may be defined as a contact surface A. With respect to a downward external force, the first flat surface 2272 may be supported by the second flat surface 272 on the contact surface A.

Accordingly, when the heater 50 is inserted into the stick S, although the stick S applies a downward external force to the mount 220, downward separation of the mount 220 from the pipe 210 may be prevented.

A first sliding edge 2273 may be defined as a portion forming an edge at an end of the engaging portion 227 with respect to a direction in which the engaging portion 227 protrudes. A second sliding edge 273 may be defined as a portion forming an edge at an end of the hook 270 with respect to a direction in which the second flat surface 272 protrudes. The first sliding edge 2273 and the second sliding edge 273 may define an edge of the contact surface A. The first sliding edge 2273 may be referred to as an engaging portion edge 2273. The second sliding edge 273 may be referred to as a hook edge 273.

Any one of first sliding edges 2273 and any one of second sliding edges 273 may intersect at two contact points B. The contact surface A may gradually decrease in area toward both contact points B along the grip direction DG. The first sliding edge 2273 may extend from the contact point B to an outside of the contact surface A. A section in which the first sliding edge 2273 extends from the contact point B to the outside of the contact surface A may be referred to as a bending section 2273a. The second sliding edge 273 may extend from the contact point B to the outside of the contact surface A.

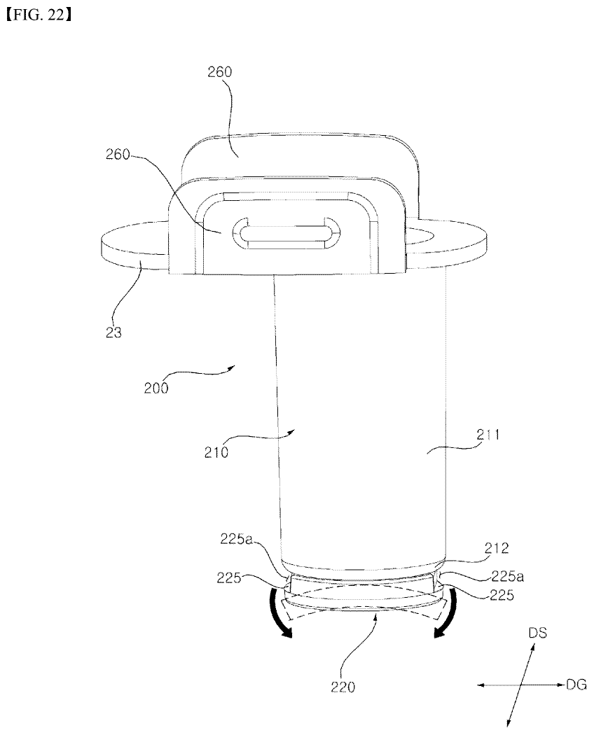

Accordingly, when inserting or removing the heater 50 into or from the stick S, the mount 220 and the heater 50 may be securely fixed without being separated from the heater module 200, and the mount 220 may be easily detached from the pipe 210 by bending the mount 220 (see FIG. 22). This will be described in detail hereinafter.

Referring to FIGS. 21 to 23, the pair of mount grips 225 may be formed at both ends of the mount 220 with respect to the grip direction DG. The mount grip 225 and the mount grip recess 225a may be exposed downward of the pipe 210. The mount grip recess 225a may be disposed between the bottom 212 of the pipe 210 and the mount grip 225. The user may hold and pull at least one of the pair of mount grips 225 downward from the pipe 210. Here, the mount 220 may be bent downward using the pair of hooks 270 and the pair of engaging portions 227 provided in the axial direction DS as fixed ends.

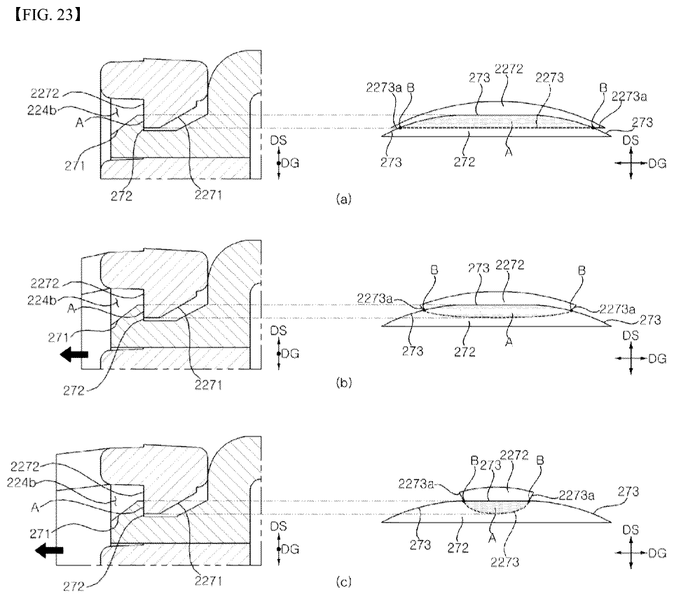

FIG. 23 illustrates that a bending angle of the mount 220 from the fixed ends increases sequentially from (a) and (b) to (c). The contact surface A may gradually decrease in area toward both contact points B along the grip direction DG. When bending the mount 220, the bending section 2273a of the first sliding edge 2273 that extends from the contact point B to the outside of the contact surface A may not receive resistance of the hook 270. Accordingly, when the mount 220 is bent, the bending section 2273a may be bent together in a direction in which the mount 220 bends. The bending section 2273a may come in sliding contact with the second sliding edge 273, and may stretch outward of the outer peripheral wall 223 of the mount 220. A length of the first sliding edge 2273 that extends from the contact point B to the outside of the contact surface A may increase as the bending angle of the mount 220 increases. A distance between two contact points B may decrease as the bending angle of the mount 220 increases.

Accordingly, as the bending angle of the mount 220 increases, the contact surface A between the hook 270 and the engaging portion 227 may decrease, causing a fastening force between the hook 270 and the engaging portion 227 to be gradually reduced until being separated from each other.

Thus, when inserting or removing the heater 50 into or from the stick S, the mount 220 and the heater 50 may be securely fixed without being separated from the heater module 200, and the mount 220 may be easily detached from the pipe 210 by bending the mount 220.

Referring to FIGS. 1 to 23, an aerosol generating device according to one aspect of the present disclosure may include: a body defining a first insertion space having an upper opening; a heater holder configured to be coupled to a heater and inserted into the first insertion space and defining a second insertion space having an upper opening; and an extractor configured to be inserted into the second insertion space and defining a third insertion space having an upper opening.

According to another aspect of the present disclosure, the aerosol generating device may further include an upper case configured to be detachably coupled to the body to cover an upper portion of the body, wherein the extractor may be coupled to the upper case and the upper case comprises an insertion hole communicating the opening of the third insertion space to an outside.

According to another aspect of the present disclosure, the heater holder may be detachably coupled to the upper case.

According to another aspect of the present disclosure, the aerosol generating device may further include: a first coupling member included at the heater holder; and a second coupling member included at the upper case, wherein the first coupling member and the second coupling member may couple the heater holder and the upper case via attractive force.

According to another aspect of the present disclosure, the heater holder may protrude downward from the upper case when the heater holder and the upper case are coupled.

According to another aspect of the present disclosure, the heater holder may comprise a heater holder wing extending over an outer surface of the upper case when the heater holder and the upper case are coupled.

According to another aspect of the present disclosure, the heater holder may be detachably coupled to the body.

According to another aspect of the present disclosure, the aerosol generating device may further include: a first coupling member disposed at the heater holder; and a third coupling member disposed at the body, wherein the first coupling member and the third coupling member may couple the heater holder and the body via attractive force.

According to another aspect of the present disclosure, the heater holder may be detachably coupled to each of the upper case and the body.

According to another aspect of the present disclosure, the aerosol generating device may further include: a first coupling member disposed at the heater holder; a second coupling member disposed at the upper case, wherein the first coupling member and the second coupling member are coupled together via a first attractive force; and a third coupling member disposed at the body, wherein the first coupling member and the third coupling member may be coupled together via a second attractive force.

According to another aspect of the present disclosure, a strength of the first attractive force may be different from a strength of the second attractive force.

According to another aspect of the present disclosure, the heater holder may include: a pipe defining the second insertion space; and an extension portion extending outwardly from the pipe near the upper opening of the second insertion space.

According to another aspect of the present disclosure, the aerosol generating device may further include: a first coupling member disposed at the extension portion; and a third coupling member disposed at the body, wherein the first coupling member and the third coupling member may couple the heater holder and the body via attractive force.

According to another aspect of the present disclosure the extension portion is configured to be supported by the body when the heater holder is inserted into the first insertion space such that an air gap in the first insertion space is defined between a outer surface of the pipe and an inner wall of a body pipe of the body defining the first insertion space.

According to another aspect of the present disclosure, the aerosol generating device may further include: an upper case configured to be detachably coupled to the body to cover an upper portion of the body, wherein the extractor may be coupled to the upper case and the upper case comprises an insertion hole providing access to the third insertion space; a first coupling member disposed at the extension portion; and a second coupling member disposed at the upper case, wherein the first coupling member and the second coupling member may couple the heater holder and the upper case via attractive force.

According to another aspect of the present disclosure, the heater may protrude upward from a bottom of the heater holder into the second insertion space, and wherein the extractor may comprise a through-hole at a bottom of the third insertion space such that the heater passes through the through-hole to be disposed in the third insertion space when the extractor is inserted into the second insertion space.

According to another aspect of the present disclosure, the aerosol generating device may further include an upper case configured to be detachably coupled to the body to cover an upper portion of the body, wherein the extractor may be coupled to the upper case and the upper case may comprise an insertion hole communicating the opening of the third insertion space to an outside, and wherein an air gap in the second insertion space may be defined between a outer surface of the extractor and an inner surface of a pipe of the heater holder defining the second insertion space.

According to another aspect of the present disclosure, the aerosol generating device may further include an induction coil surrounding the first insertion space and configured to cause the heater to generate heat.

According to another aspect of the present disclosure, the heater holder may be detachably coupled to the extractor.

According to another aspect of the present disclosure, the upper case may include a cap that opens and closes the insertion hole.

Referring to FIGS. 1 to 23, an aerosol generating device according to one aspect of the present disclosure may include: a body providing a first insertion space open at top; a pipe detachably inserted into the first insertion space, providing a second insertion space open at top and bottom, and provided with a hook at a lower end thereof; and a mount provided with an engaging portion fastened to the hook, covering the bottom opening of the second insertion space, and to which a heater protruding to the second insertion space is fixed.

According to another aspect of the present disclosure, the hook and the engaging portion may define a contact surface in a horizontal direction when fastened to each other.

According to another aspect of the present disclosure, the hook may be provided in pair, and the pair of hooks may be provided on both sides of the lower end of the pipe. The engaging portion may be provided in pair, and the pair of engaging portions may be provided on both sides of the mount.

According to another aspect of the present disclosure, the mount may be configured to be bent downward using the pair of engaging portions as a fixed end, so as to be detached from the pipe.

According to another aspect of the present disclosure, an area of the contact surface may decrease as a bending angle of the mount increases.

According to another aspect of the present disclosure, the aerosol generating device may further include: a first sliding edge defining an edge of an end of the engaging portion; and a second sliding edge defining an edge of an end of the hook.

According to another aspect of the present disclosure, the first sliding edge and the second sliding edge may define an edge of the contact surface and intersect each other at a contact point. The contact surface may gradually decrease in area toward the contact point. The first sliding edge may include a bending section extending from the contact point to an outside of the contact surface, so as to bend together with the mount.

According to another aspect of the present disclosure, when the mount is bent, the bending section may bend to come in sliding contact with the second sliding edge to thereby decrease the area of the contact surface.

According to another aspect of the present disclosure, the mount may include a mount grip protruding from an outer peripheral wall at a position non-overlapping with the fixed end.

According to another aspect of the present disclosure, the aerosol generating device may further include: a pipe rim formed at the lower end of the pipe; and a rim insertion recess formed between an outer peripheral wall and an inner peripheral wall of the mount, and open at top to allow the pipe rim to be inserted therein.

According to another aspect of the present disclosure, the hook may protrude outward from the pipe rim. The engaging portion may protrude inward from the outer peripheral wall.

According to another aspect of the present disclosure, at least one of the hook and the engaging portion may include an inclined surface that pushes the engaging portion and the outer peripheral wall to stretch outward when the hook is fastened to the engaging portion.

According to another aspect of the present disclosure, the aerosol generating device may further include a deformation hole formed by opening a bottom of the mount under the engaging portion and in communication with the rim insertion recess.

According to another aspect of the present disclosure, the pipe rim may be press-fitted between the outer peripheral wall and the inner peripheral wall.

According to another aspect of the present disclosure, the pipe rim and the mount may be configured to be engaged with each other in a circumferential direction.

According to another aspect of the present disclosure, the heater and the mount may be configured to be engaged with each other in a circumferential direction.

According to another aspect of the present disclosure, the aerosol generating device may further include an extractor detachably inserted into the second insertion space, providing a third insertion space open at top, and provided at a bottom thereof with a through-hole through which the heater passes.

According to another aspect of the present disclosure, the aerosol generating device may further include an induction coil surrounding the first insertion space and allowing the heater to generate heat.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

1. An aerosol generating device comprising:
a body defining a first insertion space having an upper opening;
a heater holder configured to be coupled to a heater and inserted into the first insertion space and defining a second insertion space having an upper opening; and
an extractor configured to be inserted into the second insertion space and defining a third insertion space having an upper opening.

2. The aerosol generating device of claim 1, further comprising an upper case configured to be detachably coupled to the body to cover an upper portion of the body,
wherein the extractor is coupled to the upper case and the upper case comprises an insertion hole communicating the opening of the third insertion space to an outside.

3. The aerosol generating device of claim 2, wherein the heater holder is detachably coupled to the upper case.

4. The aerosol generating device of claim 3, further comprising:
a first coupling member included at the heater holder; and
a second coupling member included at the upper case,
wherein the first coupling member and the second coupling member couple the heater holder and the upper case via attractive force.

5. The aerosol generating device of claim 3, wherein the heater holder protrudes downward from the upper case when the heater holder and the upper case are coupled.

6. The aerosol generating device of claim 3, wherein the heater holder comprises a heater holder wing extending over an outer surface of the upper case when the heater holder and the upper case are coupled.

7. The aerosol generating device of claim 1, wherein the heater holder is detachably coupled to the body.

8. The aerosol generating device of claim 7, further comprising:
a first coupling member disposed at the heater holder; and
a third coupling member disposed at the body,
wherein the first coupling member and the third coupling member couple the heater holder and the body via attractive force.

9. The aerosol generating device of claim 2, wherein the heater holder is detachably coupled to each of the upper case and the body.

10. The aerosol generating device of claim 9, further comprising:
a first coupling member disposed at the heater holder;
a second coupling member disposed at the upper case, wherein the first coupling member and the second coupling member are coupled together via a first attractive force; and
a third coupling member disposed at the body, wherein the first coupling member and the third coupling member are coupled together via a second attractive force.

11. The aerosol generating device of claim 10, wherein a strength of the first attractive force is different from a strength of the second attractive force.

12. The aerosol generating device of claim 1, further comprising:
an upper case configured to be detachably coupled to the body to cover an upper portion of the body,
a second coupling member disposed at the upper case, and
a third coupling member disposed at the body,
wherein the extractor is coupled to the upper case and the upper case comprises an insertion hole communicating the opening of the third insertion space to an outside,
wherein the heater holder comprises:
a pipe defining the second insertion space;
an extension portion extending outwardly from the pipe near the upper opening of the second insertion space, and
a first coupling member disposed at the extension portion,
wherein the first coupling member and the third coupling member couple the heater holder and the body via attractive force, and
wherein the first coupling member and the second coupling member couple the heater holder and the upper case via attractive force.

13. The aerosol generating device of claim 12, wherein the extension portion is configured to be supported by the body when the heater holder is inserted into the first insertion space such that an air gap in the first insertion space is defined between a outer surface of the pipe and an inner wall of a body pipe of the body defining the first insertion space.

14. The aerosol generating device of claim 1, wherein the heater protrudes upward from a bottom of the heater holder into the second insertion space, and
wherein the extractor comprises a through-hole at a bottom of the third insertion space such that the heater passes through the through-hole to be disposed in the third insertion space when the extractor is inserted into the second insertion space,
wherein the aerosol generating device further comprising an induction coil surrounding the first insertion space and configured to cause the heater to generate heat.

15. The aerosol generating device of claim 1, further comprising an upper case configured to be detachably coupled to the body to cover an upper portion of the body,
wherein the extractor is coupled to the upper case and the upper case comprises an insertion hole communicating the opening of the third insertion space to an outside, and
wherein an air gap in the second insertion space is defined between a outer surface of the extractor and an inner surface of a pipe of the heater holder defining the second insertion space.
